(19) United States
(12) Patent Application Publication
(10) Pub. No.: US 2012/0215645 A1
(43) Pub. Date: Aug. 23, 2012

(54) ADVERTISEMENT SYSTEM AND METHOD BASED ON TRAFFIC QUALITY

(75) Inventors: Hyun Mee CHUNG, Seongnam-si (KR); Sang Chul LEE, Seongnam-si (KR)

(73) Assignee: NHN BUSINESS PLATFORM CORP., Seongnam-si (KR)

(21) Appl. No.: 13/217,548

(22) Filed: Aug. 25, 2011

(30) Foreign Application Priority Data
Aug. 25, 2010 (KR) 10-2010-0082522

(51) Int. Cl. G06Q 30/02

(52) U.S. Cl. 705/14.71; 705/14.69

(57) ABSTRACT

An advertisement system and method based on a traffic quality of a medium are provided. The advertisement system, in which an advertiser selects a medium on which an advertisement of the advertiser is to be displayed, may include an advertisement cost calculating unit to calculate an advertisement cost for the advertisement of the advertiser based on a quality indicator of the selected medium.

### CROSS REFERENCE TO RELATED APPLICATION

This application claims priority from and the benefit of Korean Patent Application No. 10-2010-0082522, filed on Aug. 25, 2010, which is hereby incorporated by reference for all purposes as if fully set forth herein.

### BACKGROUND OF THE INVENTION

1. Field of the Invention

Exemplary embodiments of the present invention relate to an advertisement system and method based on a traffic quality of a medium for displaying an advertisement.

2. Discussion of the Background

In a conventional advertisement system, an advertisement display ranking and a cost per click (CPC) are determined by bidding performed by an advertiser, and the same charge is applied regardless of the website used to display an advertisement.

However, even when a user takes the same action on the same advertisement, a value of the action having an influence on an advertiser may vary depending on the website on which the advertisement is displayed. Accordingly, there is a need to develop a method and system that may differentiate charges for advertisements in association with a user's actions.

### SUMMARY OF THE INVENTION

Exemplary embodiments of the present invention provide an advertisement system and advertisement method that may charge different advertisement costs for the same advertisements based on traffic qualities of different providing paths.

Additional features of the invention will be set forth in the description which follows, and in part will be apparent from the description, or may be learned by practice of the invention.

Exemplary embodiments of the present invention disclose an advertisement system comprising a processor to calculate a cost for an advertisement of an advertiser based on a quality indicator of a selected medium. The advertisement is displayed on the selected medium.

Exemplary embodiments of the present invention also disclose an advertisement method including determining a cost for an advertisement of an advertiser based on a quality indicator of a medium selected by the advertiser. The advertisement is displayed on the selected medium.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a diagram illustrating an environment in which a system for differentiating charges for each publisher is constructed according to exemplary embodiments of the present invention.

FIG. 2 is a block diagram illustrating a configuration of an advertisement system 200 according to exemplary embodiments of the present invention.

FIG. 3 is a diagram illustrating examples of websites selected by advertisers and examples of advertisers and corresponding websites, according to exemplary embodiments of the present invention.

FIG. 4 is a table showing examples of an advertiser, a bid price, a number of selections, a quality indicator, and a charge based on a display ranking for each publisher, according to exemplary embodiments of the present invention.

FIG. 5 is a flowchart illustrating an advertisement method according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

The terminology used herein is for the purpose of describing exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It may be understood that for the purposes of this disclosure, “at least one of X, Y, and Z” can be construed as X only, Y only, Z only, or any combination of two or more items X, Y, and Z (e.g., XYZ, XYY, YZ, ZZ).

Hereinafter, exemplary embodiments of the present invention are described in detail with reference to the accompanying drawings.

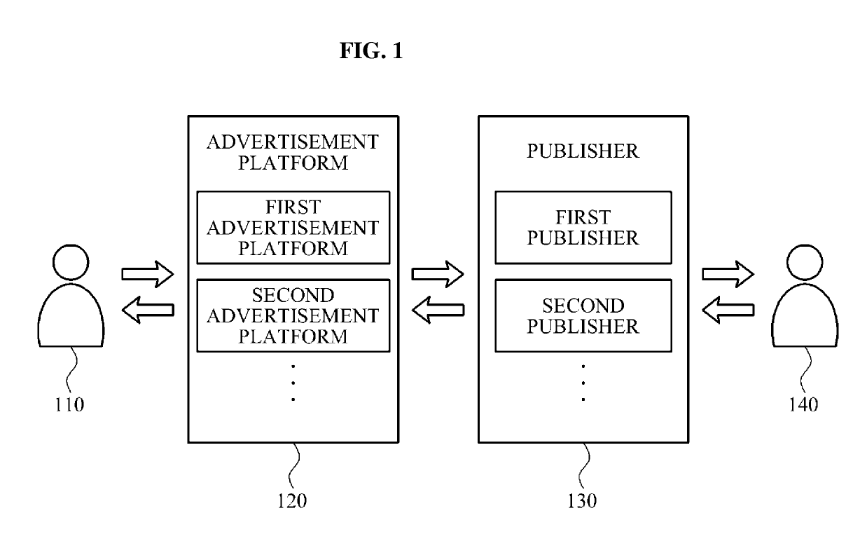

FIG. 1 is a diagram illustrating a system that differentiates charges for each publisher according to exemplary embodiments of the present invention. The system illustrated in FIG. 1 may include an advertiser 110, an advertisement platform 120, a publisher 130, and a user 140. The advertiser 110 and the user 140 may use terminals, for example, a Personal Computer (PC), a smart phone, a mobile terminal, an electronic pad, or, in general, any suitable wireless electronic device to interact with the advertisement platform 120 and the publisher 130. Data may be transmitted or received using a wired or wireless network between a terminal used by the advertiser 110 and a terminal used by the advertisement platform 120, the publisher 130, and/or the user 140. Examples of the wired or wireless network include, but are not limited to, coaxial and/or fiber optics-based wired networks, wireless wide area networks (WANs), wireless metropolitan area networks (WMANs), wireless mesh networks, Worldwide Interoperability for Microwave Access (WiMAX), Ethernet-based networks, cellular networks, and other broadband wireless microwave and radio frequency networks.

The advertisement platform 120 may provide a platform to bid for an advertisement of the advertiser 110, may match a keyword with an advertisement, may arrange advertisements and/or advertisers, and may charge a fee according to display of an advertisement. The advertisement platform 120 may include, for example, at least one of a search advertisement platform and a banner advertisement platform.

The publisher 130 may receive a keyword input by the user 140, and may provide the user 140 with a search result according to the keyword. For example, the publisher 130 may transfer the keyword input by the user 140 to the advertisement platform 120, may receive an advertisement associated with the keyword from the advertisement platform 120, and may provide the user 140 with the received advertisement as the search result.

The publisher 130 may provide a path via which the user 140 directly receives the provided advertisement, and advertisements may be provided through a website via the Internet. In some cases, the publisher 130 may be a publisher of a website. The advertisement platform 120 may include a plurality of individual advertisement platforms, for example, a first advertisement platform and a second advertisement platform. The publisher 130 may include a plurality of individual publishers, for example, a first publisher and a second publisher. Each of the plurality of individual advertisement platforms in the advertisement platform 120 may provide an advertisement through at least one individual publisher among the plurality of individual publishers in the publisher 130.

Additionally, each of the plurality of individual publishers may provide the user 140 with at least one of various services through at least one website, respectively. The various services may include, for example, an integrated search service, a keyword search service, a blogging service, as well as an advertisement display service.

The plurality of individual advertisement platforms may enable the advertiser 110 to directly select an individual publisher that the advertiser 110 may desire to display an advertisement of the advertiser 110 from among the plurality of individual publishers. For example, an advertiser may directly select an advertisement-providing publisher during bidding for an advertisement. A criterion for selecting the advertisement-providing publisher may be provided to the advertiser by the advertisement platform 120.

The advertisement platform 120 may charge different fees for the same advertisement and/or for the same keyword, by using a quality indicator associated with each of the individual publishers whom may be connected to the advertisement platforms of the advertisement platform 120. For example, when the same advertisement of the advertiser 110 is displayed based on the same keyword through the first publisher and the second publisher, and when a quality indicator of the first publisher is different from a quality indicator of the second publisher, each of the individual advertisement platforms may charge different fees for the display of the advertisement of the advertiser 110.

A quality indicator may be estimated and measured using various methods. For example, in some cases, only a single quality indicator may be measured with respect to a single publisher. In some cases, various quality indicators may be measured with respect to a single publisher. The various quality indicators may include, for example, quality indicators for each advertisement, quality indicators for each keyword, quality indicators for each advertiser, and quality indicators for each advertising time.

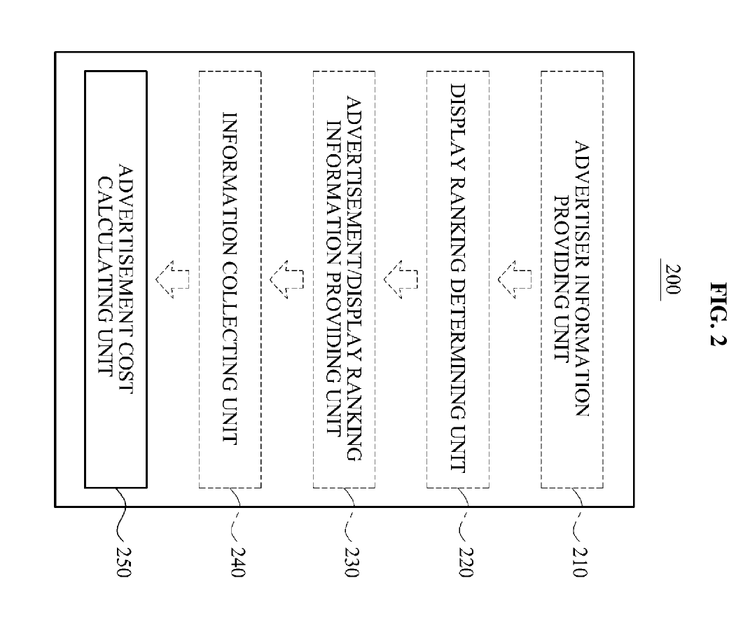

FIG. 2 is a block diagram illustrating a configuration of an advertisement system 200 according to exemplary embodiments of the present invention. The advertisement system 200 may include an advertiser information providing unit 210, a display ranking determining unit 220, an advertisement/display ranking information providing unit 230, an information collecting unit 240, and an advertisement cost calculating unit 250. The advertisement system 200 may be included in one of the individual advertisement platforms of FIG. 1.

The advertisement system 200 may include the advertisement cost calculating unit 250. In some cases, at least one of the advertiser information providing unit 210, the display ranking determining unit 220, the advertisement/display ranking information providing unit 230, and the information collecting unit 240 may be included in another system connected to the advertisement system 200, instead of being included in the advertisement system 200.

For example, a separate system, separate from the advertisement system 200, may perform a function of selling and bidding for an advertisement and may use information about the selling and bidding. In this example, the display ranking determining unit 220 may collect, from the separate system, information required to determine an advertisement display ranking for each website. The required information may include, for example, information on an advertiser selecting a corresponding website, information on a keyword the advertiser desires to bid on, information on a bid of an advertiser with respect to a keyword, and information on a past advertising execution performance. At least one of the advertiser information providing unit 210, the advertisement/display ranking information providing unit 230, and the information collecting unit 240 may be included in the separate system.

The advertiser information providing unit 210 may provide information on advertisers who select at least one website from among a plurality of websites. Additionally, the advertiser information providing unit 210 may provide the advertisers with information on other advertisers who select a keyword and a publisher. The advertisers may determine bidding parameters, such as bid prices, using the provided information on the other advertisers. Accordingly, the advertisers may identify, based on the information on the other advertisers, an advertiser who is in competition with other advertisers for displaying an advertisement corresponding to the same keyword on the at least one selected website.

The plurality of websites may refer to websites that may each display at least one advertisement. A website may display advertisements and may be provided to users via a wired or wireless network and the Internet, and may include at least one webpage that forms a website. The term “website” may be used interchangeably with a term “publishing website” or “publisher.” Accordingly, the plurality of websites may respectively correspond to the plurality of individual publishers of FIG. 1.

Display of an advertisement may include providing a website with promotional content including, but not limited to, for example, texts, images, sound, moving images, and hyperlinks that may be associated with an advertiser corresponding to the advertisement.

An advertiser may select to display advertisements corresponding to promotional content, such as texts and images, in response to a website visitor's action, for example clicking a mouse on the promotional content. Display of the advertisement may include, for example, displaying a page associated with the advertiser to the website visitor.

The display ranking determining unit 220 may determine a display ranking of advertisements of a plurality of advertisers. The advertisements may be displayed on websites selected, respectively, by the plurality of advertisers from among the plurality of websites.

Advertisers associated with advertisements for which display ranking is to be determined, may refer to advertisers who selected the same website as an advertisement display medium from among the plurality of websites. The display ranking determining unit 220 may determine a display ranking of advertisements of advertisers who selected the same website, so that the advertisements may be displayed on the same selected website in the determined display ranking.

An advertiser may select a website on which an advertisement of the advertiser is to be displayed. Selection of a preset website used to display the advertisement may be agreed upon. Accordingly, advertisements to be displayed may be determined based on the selection of a website, despite the advertisements corresponding to the same search keyword. Additionally, a ranking in which a predetermined advertisement is displayed as a result of searching for and/or matching the same keyword may also be determined based on a website on which the predetermined advertisement is displayed.

To determine an advertisement display ranking, the display ranking determining unit 220 may use known advertisement arrangement methods. For example, the display ranking determining unit 220 may receive, as a bid price input by an advertiser, information on a cost that the advertiser is willing to pay for selection or display of an advertisement, and may determine a display ranking of the advertisement based on the input bid price. Various factors other than the bid price may be further considered to determine the advertisement display ranking, for example a past execution performance for a corresponding advertisement, a reliability of an advertiser, a keyword for an advertisement, a correlation between an advertisement and content that may be displayed along with the advertisement, and a highest ranking and a lowest ranking provided by an advertiser.

An advertiser may set different bid prices for each website that the advertiser desires to display an advertisement of the advertiser. Accordingly, the advertiser may enter a bid price for each website or may enter a reference bid price, and may assign a weight for each website.

Different display ranking determination methods may be applied to websites that display advertisements. Independent bidding may be performed for each website on which an advertisement is displayed. In other words, independent bidding may be performed with respect to a single website by advertisers who select the single website. For example, the advertisement system 200 may determine a display ranking of advertisements to be displayed on a website through bidding using a cost per display-mechanism to determine a bid price, and may determine a display ranking of advertisements to be displayed on another website through bidding using a cost per click (CPC)-mechanism to determine a bid price. Additionally, the advertisement system 200 may measure a quality indicator of an advertisement to be displayed on another website, by quantifying a quality of the advertisement, and may determine a display ranking by reflecting the measured quality indicator as a weight on a bid price. Furthermore, when a plurality of advertisements are displayed together on a single advertisement area in a single website, a display ranking of the plurality of advertisements may refer to a display ranking in which each of the plurality of advertisements is to be displayed. Moreover, when a plurality of advertisements are sequentially displayed on a single advertisement area in a single website, a display ranking of the plurality of advertisements may refer to a display weight given to each of the plurality of advertisements to be displayed on the single advertisement area. For example, when each of a plurality of advertisements are sequentially displayed on a single advertisement area in a single website, at least one of a number of times each of the plurality of advertisements is displayed, a time during which each of the plurality of advertisements is displayed, and an area of each of the plurality of displayed advertisements may be determined based on the display weight.

The advertisement/display ranking information providing unit 230 may provide publishers with information on corresponding advertisements and information on a display ranking of the advertisements. The publishers may operate a plurality of websites. Each of the publishers may provide information on advertisements in a corresponding display ranking, based on a keyword input by a user.

The information collecting unit 240 may collect reaction information or conversion information. The reaction information or the conversion information may be associated with a reaction from a website visitor (e.g., user), who is provided with an advertisement. For example, the information collecting unit 240 may collect, for each website, information regarding display of advertisements and an action of a website visitor in response to the display. The collected information may include, for example, information regarding a number of times each of advertisements is displayed, information regarding a number of times each of advertisements is selected, information regarding whether a product is purchased in response to selection of an advertisement, information regarding whether a visitor of a website becomes a member, and information regarding whether a website visitor receives a newsletter. The collected information may be collected directly from an individual website that displays an advertisement, or may be collected due to an action of an advertisement platform in response to a click on a link included in an advertisement.

The advertisement cost calculating unit 250 may calculate an advertisement cost for an advertisement, based on a quality indicator of a website selected by the advertiser from among a plurality of websites. The advertisement may be displayed on the selected website. To calculate an advertisement cost, the advertisement cost calculating unit 250 may use a quality indicator associated with a website on which an advertisement is displayed. The quality indicator may be calculated for each publisher that publishes an advertisement and accordingly, may be referred to as a “publisher quality indicator.”

When using a quality indicator as a weight for calculating a charge for an advertisement, how much the quality indicator is reflected may be determined based on a decision of an advertisement platform operator. Additionally, a method of assigning the weight may be determined on demand by an advertiser.

An advertiser may request an exclusion of a quality indicator weight with respect to a specific publisher, and may determine how to apply a quality indicator weight and how much a quality indicator weight is applied with respect to another publisher.

As described above, advertisements of a plurality of advertisers may be displayed on at least one website selected by the plurality of advertisers, according to a display ranking determined by the display ranking determining unit 220. The information regarding display of advertisements and an action of a website visitor in response to the advertisement display may be collected by the information collecting unit 240. The advertisement system 200 may calculate advertisement costs for the displayed advertisements, using the advertisement cost calculating unit 250. To calculate the advertisement costs, the advertisement cost calculating unit 250 may reflect a quality indicator of each website. Accordingly, different advertisement costs for advertisements associated with the same advertiser may be determined based on which website is used to display the advertisements, regardless of the advertisements being the same.

The quality indicator of each website may be determined based on at least one of a number of displays, a number of clicks, a conversion rate, a Click Through Rate (CTR), and a number of abuses. The conversion rate may refer to a total number of visitors who visited a website divided by a number of visitors who performed an action induced by an advertiser from among the total visitors. For example, a quality indicator of a selected web site may be determined using a conversion rate indicating a percentage of visitors who visited a web page associated with an advertiser by clicking on a specific advertisement and who purchased a product related to the specific advertisement. Additionally, abuse may refer to an action performed to intentionally manipulate the number of displays of a website or the number of clicks on an advertisement. As the number of abuses increases, a quality of a website may decrease along with a quality indicator of the website.

Additionally, the quality indicator may be determined using a table that is set based on a characteristic of a publisher, or using an indicator that an advertiser, an operator of the advertisement system 200, or a visitor has entered with respect to a publisher. Accordingly, when the characteristic of the publisher is used, a quality indicator may be determined in advance by categorizing websites into commerce websites or information websites. In some cases, to determine the quality indicator, at least two of the above-described three methods may be used in combination. For example, the quality indicator determined based on the characteristic of the publisher may be assigned as a weight to the quality indicator determined based on at least one of the number of displays, the number of clicks, the conversion rate, the CTR, and the number of abuses.

The advertisement cost calculating unit 250 may include a weighting unit and a calculating unit (not shown). The weighting unit may assign a weight corresponding to a quality indicator of a selected website to a cost per selection of an advertisement, or to a cost per display of the advertisement, so that an advertisement cost for the advertisement may be calculated based on the quality indicator. The calculating unit may calculate the advertisement cost for the advertisement based on a number of times the advertisement is selected and the cost per selection to which the weight is assigned. In some cases, the calculating unit may calculate the advertisement cost for the advertisement based on a number of times the advertisement is displayed on the selected website and the cost per display to which the weight is assigned.

For example, when an advertisement cost is determined based on a number of times an advertisement is displayed on a selected website or based on a number of times the advertisement is selected, the advertisement cost calculating unit 250 may assign a weight corresponding to a quality indicator of the selected website to a cost per display or a cost per selection that is entered as a bid price by an advertiser, as described above, and may calculate the advertisement cost based on a result of an operation between either the cost per display or the cost per selection and either the number of times of selection of the advertisement or the number of times the advertisement is displayed.

In some cases, the advertisement cost calculating unit 250 may assign a weight corresponding to a quality indicator of a selected website to a result of an operation between a number of times an advertisement is selected and a cost per selection of the advertisement, or to a result of an operation between a number of times the advertisement is displayed on the selected website and a cost per display of the advertisement, and may calculate an advertisement cost for the advertisement according to the weight.

According to exemplary embodiments of the invention, the operations and weighting may be performed using various suitable means. Additionally, as described above, the quality indicator may be a weight corresponding to the cost per selection and/or the cost per display for an advertisement. However, an operation of reflecting a quality indicator on calculation of costs for advertising execution is not limited to the exemplary embodiments described hereinabove. Accordingly, a scheme of reflecting the quality indicator may be changed.

As described above, bidding by advertisers who select a corresponding web site based on a traffic quality of the website may enable independent bidding for each website. Additionally, when the same advertisements are displayed on different websites, different advertisement costs may be charged for the same advertisements based on the traffic quality of each of the different web sites.

Using a website traffic quality indicator to calculate charges for an advertisement may have no relevance to whether an advertiser may individually enter a bid price for each website.

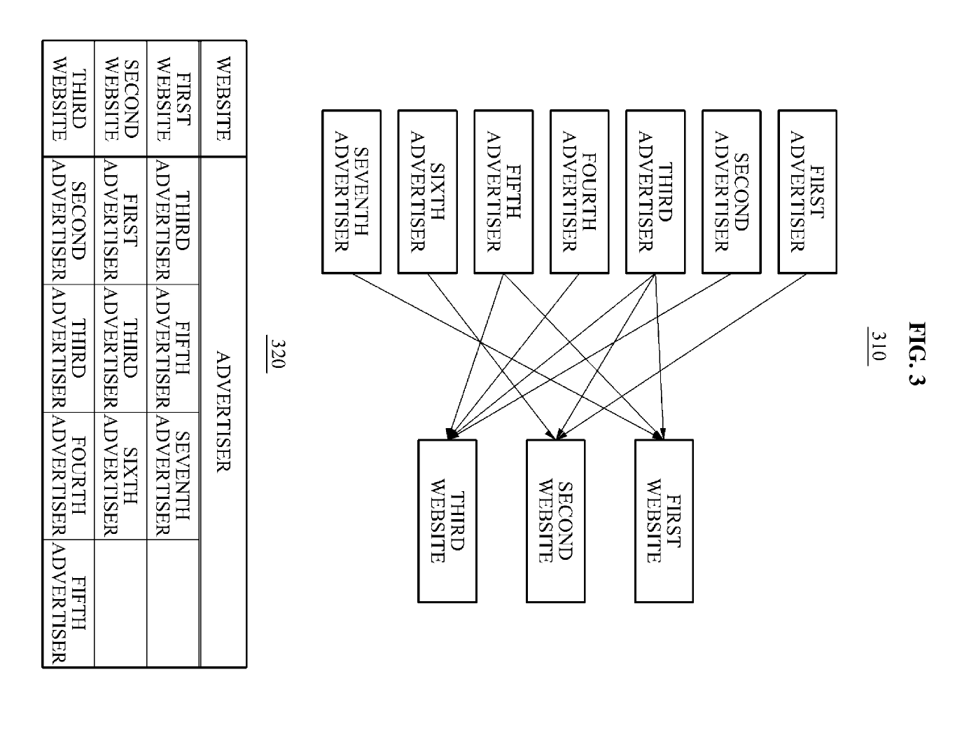

FIG. 3 is a diagram illustrating examples in which advertisers select websites, and examples of advertisers and corresponding websites, according to exemplary embodiments of the present invention.

Referring to 310 in FIG. 3, seven advertisers, for example a first advertiser, a second advertiser, a third advertiser, a fourth advertiser, a fifth advertiser, a sixth advertiser and a seventh advertiser, may each select at least one website from among a first website, a second website, and a third website. The first advertiser, the second advertiser, the fourth advertiser, the sixth advertiser and the seventh advertiser may each select a single website. The fifth advertiser may select two websites, and the third advertiser may select three websites.

Referring to Table 320, the first website may be selected by the third advertiser, the fifth advertiser, and the seventh advertiser. The second website may be selected by the first advertiser, the third advertiser, and the sixth advertiser. The third website may be selected by the second advertiser, the third advertiser, the fourth advertiser, and the fifth advertiser. For example, the third website may display advertisements of the second advertiser, the third advertiser, the fourth advertiser, and the fifth advertiser. An advertisement system 200 may determine a display ranking of the advertisements of the second advertiser, the third advertiser, the fourth advertiser, and the fifth advertiser, and may calculate advertisement costs incurred by display or selection of the advertisements.

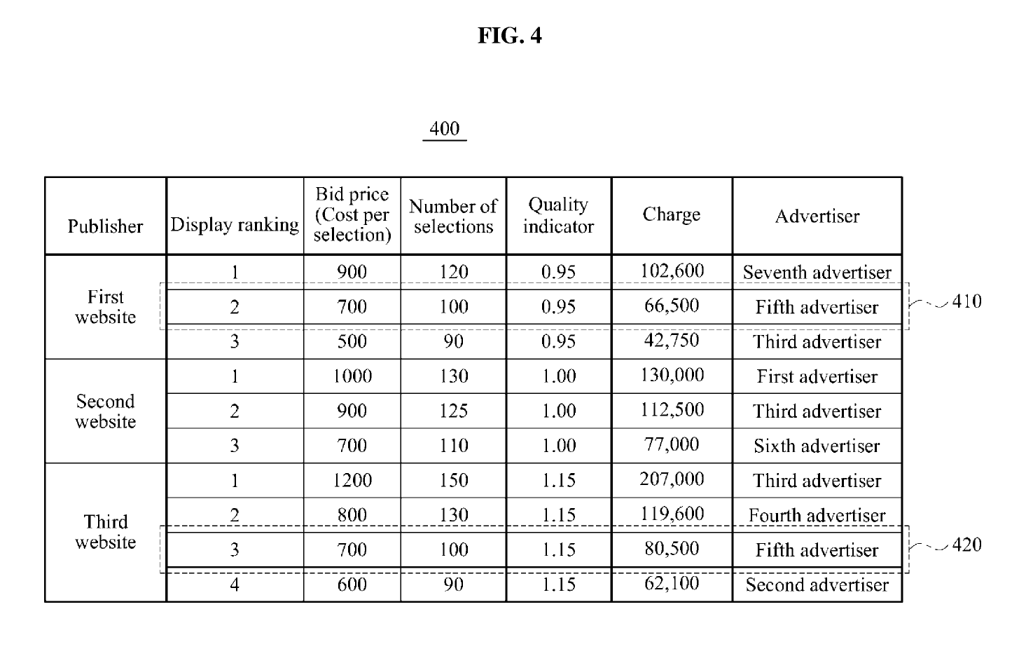

FIG. 4 illustrates a Table 400 showing examples of an advertiser, a bid price, a number of selections, a quality indicator, and a charge based on a display ranking for each publisher, according to exemplary embodiments of the present invention. The Table 400 may show display rankings associated with advertisements for each of the first website, second website, and third website of FIG. 3.

Table 400 shows the display ranking for each publisher of advertisements corresponding to the same keyword. As shown in a first dotted box 410 and a second dotted box 420 of FIG. 4, the same advertiser, for example, the fifth advertiser, may bid for the first website and the third website based on the same bid price, i.e., the same cost per selection. However, different charges may be determined based on a quality indicator of each of the websites, despite the same bid price, (e.g., 700) and the same number of selections (e.g., 100), as illustrated in Table 400. For example, the fifth advertiser may bid for the first website and the third website based on the same bid price of 700, and each of the first website and the third website are selected 100 times. However, a charge for the first website may be “66,500” and a charge for the third website may be “80,500”.

Thus, bidding by advertisers who select a corresponding website based on a traffic quality of the website may enable independent bidding for each website. Additionally, when same advertisements are displayed on different websites, different advertisement costs may be charged for the same advertisements based on a traffic quality of each of the different websites.

Exemplary embodiments using the cost per selection have been described with reference to FIG. 4, however, a cost per display may also be used as a bid price, instead of the cost per selection. In addition, a display ranking may be determined by assigning various weights, rather than directly applying a bid price. For example, a quality indicator of an advertisement may be measured by quantifying a quality of the advertisement, the measured quality indicator may be assigned as a weight to a bid price, and a display ranking may be determined based on the bid price to which the measured quality indicator is assigned. The bid price may also be used to calculate a charge.

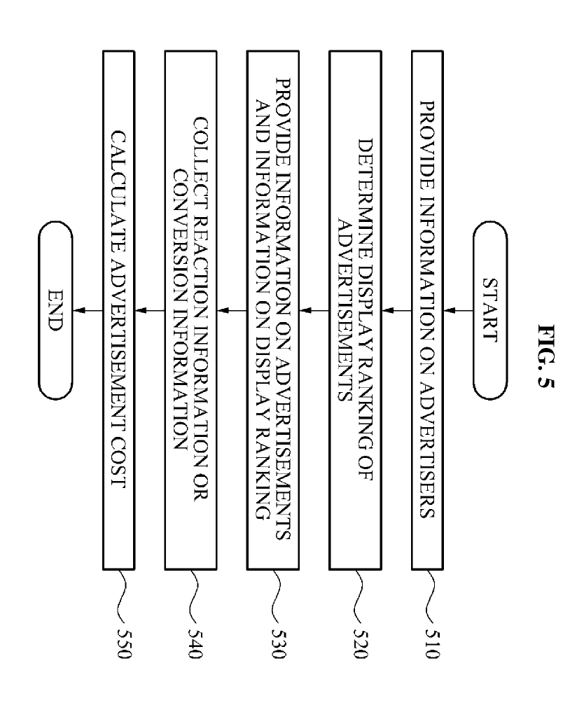

FIG. 5 is a flowchart illustrating an advertisement method according to exemplary embodiments of the present invention. The advertisement method of FIG. 5 may be performed by one of the individual advertisement platforms of FIG. 1, or by the advertisement system 200 of FIG. 2. The advertisement method of FIG. 5 may be performed by a single advertisement platform, but is not limited to a single advertisement platform.

In 510, a single advertisement platform may provide information on advertisers who select at least one of a plurality of websites. The single advertisement platform may provide the advertisers with information on other advertisers who select a keyword and a publisher. The advertisers may determine bidding conditions such as their bid prices using the provided information on the other advertisers. Accordingly, the advertisers may identify, based on the information on the other advertisers, an advertiser who is in competition with the advertisers in association with displaying of an advertisement corresponding to the same keyword on the at least one selected website.

In 520, the single advertisement platform may determine a display ranking of advertisements. The advertisements may be displayed on websites selected by the plurality of advertisers from among the plurality of websites.

Advertisers, who select the same website as an advertisement display medium from among the plurality of websites, may have their respective advertisements ranked. In other words, the single advertisement platform may determine a display ranking of advertisements of advertisers who select the same website so that the advertisements may be displayed on the same selected website in the determined display ranking.

As described above, an advertiser may select a website on which an advertisement of the advertiser is to be displayed. The selection of a preset website used to display the advertisement may be agreed upon. Accordingly, advertisements to be displayed may be determined based on the selection of the website, despite the advertisements corresponding to the same search keyword. Additionally, a ranking in which a predetermined advertisement is displayed as a result of searching for and/or matching the same keyword may also be determined based on a website on which the predetermined advertisement is displayed.

To determine an advertisement display ranking, the single advertisement platform may use known advertisement arrangement methods. For example, the single advertisement platform may receive, as a bid price input by an advertiser, information on a cost that the advertiser is willing to pay for selection or display of an advertisement, and may determine a display ranking of the advertisement based on the input bid price. Various factors other than the bid price may be further considered to determine the advertisement display ranking, for example a past execution performance for a corresponding advertisement and a reliability of an advertiser.

An advertiser may set different bid prices for each website that the advertiser desires to display an advertisement. Accordingly, the advertiser may enter a bid price for each website or may enter a reference bid price and assign a weight for each website.

Different display ranking determination methods may be applied to websites that display advertisements. Independent bidding may be performed for each website on which an advertisement is displayed. In other words, independent bidding may be performed with respect to a single website by advertisers who select the single website. For example, the single advertisement platform may determine a display ranking of advertisements to be displayed on a website through bidding using a cost per display-mechanism to determine a bid price, and may determine a display ranking of advertisements to be displayed on another website through bidding using a CPC-mechanism to determine a bid price. Additionally, the single advertisement platform may measure a quality indicator of an advertisement to be displayed on another website by quantifying a quality of the advertisement, and may determine a display ranking by reflecting the measured quality indicator as a weight on a bid price. The bidding may refer to a scheme of selecting advertisements to be displayed through bidding of advertisers. Furthermore, when a plurality of advertisements are displayed together on a single advertisement area in a single website, a display ranking of the plurality of advertisements may refer to a display ranking in which each of the plurality of advertisements is to be displayed. Moreover, when a plurality of advertisements are sequentially displayed on a single advertisement area in a single website, a display ranking of the plurality of advertisements may refer to a display weight given to each of the plurality of advertisements to be displayed on the single advertisement area. For example, when each of a plurality of advertisements are sequentially displayed on a single advertisement area in a single website, at least one of a number of times each of the plurality of advertisements is displayed, a time during which each of the plurality of advertisements is displayed, and an area of each of the plurality of displayed advertisements may be determined based on the display weight.

In 530, the single advertisement platform may provide publishers with information on corresponding advertisements and information on a display ranking of the advertisements. The publishers may operate a plurality of websites. Each of the publishers may provide information on advertisements in a corresponding display ranking based on a keyword input by a user.

In 540, the single advertisement platform may collect reaction information or conversion information. The reaction information or the conversion information may be associated with a response from a website visitor who is provided with an advertisement. For example, the single advertisement platform may collect, for each website, information regarding a display of advertisements and an action of a website visitor who responds to the display. The collected information may include, for example, information regarding a number of times each of the advertisements is displayed, information regarding a number of times each of advertisements is selected, information regarding whether a product is purchased in response to selection of an advertisement, information regarding whether a visitor of a website becomes a member, and information regarding whether a website visitor receives a newsletter.

In 550, the single advertisement platform may calculate an advertisement cost for an advertisement based on a quality indicator of a website selected by the advertiser from among a plurality of websites. The advertisement may be displayed on the selected website. To calculate an advertisement cost, the single advertisement platform may use a quality indicator associated with a website on which an advertisement is displayed. The quality indicator may be calculated for each publisher that displays an advertisement and accordingly, may be referred to as a “publisher quality indicator.”

As described above, advertisements of a plurality of advertisers may be displayed on at least one website selected by the plurality of advertisers in a display ranking determined in operation 520. The information regarding display of advertisements and an action of a website visitor in response to the display may be collected in operation 540. The single advertisement platform may calculate advertisement costs for the displayed advertisements in operation 550. In calculating the advertisement costs, the single advertisement platform may reflect a quality indicator of each of the at least one website. Accordingly, different advertisement costs for advertisements associated with the same advertiser may be determined based on the website used to display the advertisements, regardless of the advertisements being the same.

The quality indicator of each website may be determined based on at least one of a number of displays, a number of clicks, a conversion rate, a CTR, and a number of abuses in association with a selected website. The conversion rate may refer to the total number of visitors of a website divided by a number of visitors who performed an action in response to an advertisement display, from among the total visitors of the website. For example, a quality indicator of a selected website may be determined using a conversion rate indicating the percentage of visitors that visited a web page associated with an advertiser by clicking on a specific advertisement and who purchased a product related to the specific advertisement. Additionally, abuse may refer to an action performed to intentionally manipulate the number of displays of a website or the number of clicks on an advertisement. As the number of abuses increases, a quality of a website may decrease along with a quality indicator of the website.

Additionally, the quality indicator may be determined using a table that is set based on a characteristic of a publisher, or using an indicator that an advertiser, an operator of the single advertisement platform, or a visitor has entered with respect to a publisher. Accordingly, when the characteristic of the publisher is used, a quality indicator may be determined in advance by categorizing websites into commerce websites or information websites. In some cases, to determine the quality indicator, at least two of the above-described three methods may be used in combination. For example, the quality indicator determined based on the characteristic of the publisher may be assigned as a weight to the quality indicator determined based on at least one of the number of displays, the number of clicks, the conversion rate, the CTR, and the number of abuses.

According to exemplary embodiments of the invention, the single advertisement platform may assign a weight corresponding to a quality indicator of a selected website, to a cost per selection of an advertisement, or to a cost per display of the advertisement, so that an advertisement cost for the advertisement may be calculated based on the quality indicator. Additionally, the single advertisement platform may calculate the advertisement cost for the advertisement based on a number of times the advertisement displayed on the selected website is selected and the cost per selection to which the weight is assigned, or based on a number of times the advertisement is displayed on the selected website and the cost per display to which the weight is assigned.

For example, when an advertisement cost is determined based on a number of times an advertisement is displayed on a selected website or based on a number of times an advertisement is selected, the single advertisement platform may assign a weight corresponding to a quality indicator of the selected website to a cost per display or a cost per selection that is entered as a bid price by an advertiser, and may calculate the advertisement cost based on a result of an operation between either the cost per display or the cost per selection and either the number of times the displayed advertisement is selected or the number of times the advertisement is displayed.

According to exemplary embodiments, the single advertisement platform may assign a weight corresponding to a quality indicator of a selected website to a result of an operation between a number of times an advertisement displayed on the selected website is selected and a cost per selection of the advertisement, or to a result of an operation between a number of times the advertisement is displayed on the selected website and a cost per display of the advertisement, and may calculate an advertisement cost for the advertisement.

According to exemplary embodiments of the invention, the operations and weighting may be performed using various suitable means. Additionally, as described above, the quality indicator may be a weight corresponding to the cost per selection and/or the cost per display for an advertisement. However, an operation of reflecting a quality indicator on calculation of costs for advertising execution is not limited to the exemplary embodiments described hereinabove. Accordingly, a scheme of reflecting the quality indicator may be changed as needed.

An advertisement system according to exemplary embodiments of the present invention may perform 550 among 510 to 550 of FIG. 5. For example, 510 to 540 of FIG. 5 may be performed by the advertisement system. However, the operations may also be performed by another system associated with the advertisement system, as needed. For example, a separate system, separate from the advertisement system, may perform a function of selling and bidding for an advertisement and may provide the advertisement system with information regarding the selling and bidding. In this example, the advertisement system may collect, from the separate system, information required to determine an advertisement display ranking for each website. The required information may include, for example, information on an advertiser selecting a corresponding website, information on a keyword the advertiser desires to bid on, information on a bid of an advertiser with respect to a keyword, and information on a past advertising execution performance. At least one of 510, 530, and 540 may be performed by the separate system.

As described hereinabove, an advertisement cost for an advertisement may be determined based on a website on which the advertisement is displayed, according to the quality indicator for each website used to display an advertisement, but there is no limitation thereto. Accordingly, an advertisement cost may be determined based on a quality indicator for each of all media enabling display of advertisements, for example, a website, a webpage included in the website, and an application that is installed and operated in a terminal. In other words, the exemplary embodiments described hereinabove with reference to FIG. 1, FIG. 2, FIG. 3, FIG. 4, and FIG. 5 may be applied equally to any suitable media enabling display of advertisements. For example, an advertisement of an advertiser may be displayed through a mobile application selected by the advertiser, and an advertisement cost for the advertisement may be determined based on a quality indicator of the selected mobile application.

Furthermore, bidding by advertisers who select a corresponding website based on a traffic quality of the website may enable independent bidding for each website. In addition, when same advertisements are displayed on different websites, different advertisement costs may be charged for the same advertisements based on a traffic quality of each of the different websites. In other words, when same advertisements are displayed on different media (e.g., websites, web pages, and applications), different advertisement costs may be charged for the same advertisements based on a traffic quality of each of the different media.

The methods according to exemplary embodiments of the present invention may be recorded in computer-readable media including program instructions to implement various operations embodied by a computer. The media may also include, alone or in combination with the program instructions, data files, and/or data structures. The program instructions recorded on the media may be those specially designed and constructed for the purposes of the example embodiments, or they may be of the kind well-known and available to those having skill in the computer software arts. Examples of computer-readable media include magnetic media such as hard disks, floppy disks, magnetic tape, optical media such as CD ROM disks and DVD, magneto-optical media such as floptical disks, and hardware devices that are specially configured to store and perform program instructions, such as read-only memory (ROM), random access memory (RAM), and flash memory. Examples of program instructions include both machine code, such as produced by a compiler, and files containing higher level code that may be executed by the computer or a processor. The described hardware devices may be configured to act as one or more software modules in order to perform the operations of the above-described exemplary embodiments of the present invention. For example, it should be understood that each of the advertisement system 200, the advertisement platform 120, and the publisher may include a storage unit, a processor, an input unit, and an output unit to execute the exemplary embodiments described herein. For example, the advertisement system 200 may include a processor to perform the various exemplary embodiments of the invention. In some cases, each of the advertiser information providing unit 210, display ranking determining unit 220, advertisement/display ranking information providing unit 230, information collecting unit 240, and the advertisement cost colleting unit 25 may include a processor and/or a storage unit to execute the various exemplary embodiments of the invention. For instance, the advertisement cost colleting unit 250 may be a processor to determine a cost for an advertisement of an advertiser based on a quality indicator of a medium selected by the advertiser.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An advertisement system, comprising:
a processor to determine a cost for an advertisement of an advertiser based on a quality indicator of a medium selected by the advertiser, the advertisement being displayed on the selected medium.

2. The advertisement system of claim 1, wherein the quality indicator of the selected medium is determined based on at least one of a number of displays, a number of clicks, a conversion rate, a Click Through Rate (CTR), and a number of abuses associated with the selected medium.

3. The advertisement system of claim 1, wherein a display ranking of advertisements of advertisers, who select at least one medium from among a plurality of media, is determined, and
wherein at least two display rankings for at least two media among the plurality of media are determined using different display ranking determination methods.

4. The advertisement system of claim 3, wherein, when a plurality of advertisements are displayed together on an advertisement area in a medium, the display ranking comprises a display ranking in which each of the plurality of advertisements is to be displayed, and
wherein, when the plurality of advertisements are sequentially displayed on the advertisement area in the medium, the display ranking comprises a display weight of each of the plurality of advertisements.

5. The advertisement system of claim 1, wherein an independent bidding is performed with respect to the medium by advertisers, who select the medium from among a plurality of media.

6. The advertisement system of claim 1, wherein the processor comprises:
a weighting unit to assign a weight to a cost per selection of the advertisement or to a cost per display of the advertisement, the assigned weight corresponding to the quality indicator of the selected medium; and
a calculating unit to calculate the cost for the advertisement, based on a number of times the displayed advertisement is selected and the cost per selection to which the weight is assigned, or based on a number of times the advertisement is displayed on the selected medium and the cost per display to which the weight is assigned.

7. The advertisement system of claim 1, wherein the processor calculates the cost for the advertisement by assigning a weight corresponding to the quality indicator of the selected medium to a result of an operation between a number of times the displayed advertisement is selected and a cost per selection of the advertisement, or to a result of an operation between a s number of times the advertisement is displayed on the selected medium and a cost per display of the advertisement.

8. The advertisement system of claim 1, wherein the advertiser selects the selected media from a plurality of media comprising at least one of a website provided through the Internet, a web page included in the website, and an application installed and operated in a terminal.

9. An advertisement method, comprising:
determining a cost for an advertisement of an advertiser based on a quality indicator of a medium selected by the advertiser, the advertisement being displayed on the selected medium.

10. The advertisement method of claim 9, wherein the quality indicator of the selected medium is determined based on at least one of a number of displays, a number of clicks, a conversion rate, a Click Through Rate (CTR), and a number of abuses associated with the selected medium.

11. The advertisement method of claim 9, wherein a display ranking of advertisements of advertisers who select at least one medium from among a plurality of media is determined, and
wherein at least two display rankings for at least two media among the plurality of media are determined using different display ranking determination methods.

12. The advertisement method of claim 11, wherein, when a plurality of advertisements are displayed together on an advertisement area in a medium, the display ranking comprises a display ranking in which each of the plurality of advertisements is to be displayed, and
wherein, when the plurality of advertisements are sequentially displayed on the advertisement area in the medium, the display ranking comprises a display weight of each of the plurality of advertisements.

13. The advertisement method of claim 9, wherein an independent bidding is performed with respect to the medium by advertisers, who select the medium from among a plurality of media.

14. The advertisement method of claim 9, wherein the determining comprises:
assigning a weight to a cost per selection of the advertisement or to a cost per display of the advertisement, the weight corresponding to the quality indicator of the selected medium; and
calculating the cost for the advertisement, based on a number of times the displayed s advertisement is selected and the cost per selection to which the weight is assigned, or based on a number of times the advertisement is displayed on the selected medium and the cost per display to which the weight is assigned.

15. The advertisement method of claim 9, wherein the determining comprises:
calculating the cost for the advertisement by assigning a weight corresponding to the quality indicator of the selected medium to a result of an operation between a number of times the displayed advertisement is selected and a cost per selection of the advertisement, or to a s result of an operation between a number of times the advertisement is displayed on the selected medium and a cost per display of the advertisement.

16. The advertisement method of claim 9, wherein the selected media is selected from a plurality of media comprising at least one of a website provided through the Internet, a web page included in the website, and an application installed and operated in a user terminal.

17. A non-transitory computer readable recording medium storing a program, that when executed, comprises instructions to cause a computer to implement the method of claim 9.
